(19) United States
(12) Patent Application Publication
(10) Pub. No.: US 2005/0187874 A1
(43) Pub. Date: Aug. 25, 2005

(54) Import compliance system and method

(76) Inventor: Ahmet Sanal, Flemington, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/062,414

(22) Filed: Feb. 22, 2005

Related U.S. Application Data
(60) Provisional application No. 60/545,986, filed on Feb. 19, 2004.

(51) Int. Cl. G06F 17/60

(52) U.S. Cl. 705/40; 705/30

(57) ABSTRACT

A system and method for managing exportation and importation of goods and managing the data and interactions of various entities involved. Timely importation of goods requires a number of various activities to be coordinated and cross-checked for accuracy and compliance. Suppliers and freight forwarders may submit invoices and shipping notifications, respectively, which may be cross-checked against various conformance requirements and checked for compliance with customs and other governmental agencies prior to submission of an entry declaration. In this way, errors or improper documentation may be avoided, often while the goods are still in the exporting country, and prior to submission of entry documents to customs. Further, a reverse compliance check may be performed on the submitted entry declaration with information supplied to a customs broker for accuracy.

### CROSS REFERENCE TO RELATED APPLICATIONS

This application claims priority to U.S. Provisional Application No. 60/545,986 filed on Feb. 19, 2004, which is incorporated by reference in its entirety herein.

### DESCRIPTION

1. Field of the Invention

The invention generally relates to a system and method for managing importation of goods and, more particularly, to a system for managing, checking for compliance of imported goods and checking accuracy of various records before and after submission of entry declarations.

2. Background

Importation of goods can be a complex and demanding process that typically requires cooperation and effective communication among multiple entities. These entities may include, for example, foreign suppliers, freight forwarders, accounting systems, shippers, customs brokers, governmental agencies including customs of the exporting and importing countries.

Coordinating proper notifications, bills, schedules, classification systems, regulation requirements, and the like, among these different entities so that accurate and timely execution of entry into importing countries may be a decisive competitive advantage when efficiently managed, or conversely, a disadvantage when poorly managed.

Among the various deficiencies of today's systems and processes are inabilities to coordinate or perform several aspects of the overall importation process including, but not limited to the following examples:
Poor verification of shipping notifications with invoices and checking of required information between them.
No provisions for checking compliance with other governmental agencys' regulations other than customs, e.g., agriculture agencies, defense agencies, food and drug agencies, security agencies, and the like.
Ineffective checking of illegal or controlled goods on invoices and shipping bills in a timely manner to avoid inadvertent shipment of these illegal or controlled goods to an importing country while they are still in the exporting country and/or prior to submission of the entry declaration to customs.
Ineffective verification of goods/parts classification listed on invoices and entry declarations that are consistent with known classification systems.
No capability of checking a customs broker's submissions for accuracy against invoices or shipping notices.
No ability to centrally track delivery status messages.
Inadequate or non-existent checking of air freight and surcharges against pre-determined schedules.
Inability to automatically notify process “owners” when a compliance issue arises to resolve a non-compliance or error expeditiously.
No method to automatically pay invoices in bulk when the invoices match expected charges and no automatic method to pay a single invoice independently when an exception or error arises on a particular invoice.

Efficient coordination of these tasks among various entities is necessary so that accurate, consistent, and timely submission of accurate entry declarations to customs takes place with little or no disruptions. Too often, goods are held or rejected by customs due to improper, inaccurate, or illegal listing of the goods on entry declarations. This may in turn have a negative affect on the operations of an importing company that expects timely delivery of the goods. Further, inaccurate accounting of the fees associated with the importation may lead to loss revenues or jeopardized business relationships between suppliers, shippers, freight forwarders, customs brokers and an importing entity. If inaccurate or otherwise improper entry declarations become too frequent, customs may even take exceptional notice and resort to increased review of imported goods.

Protecting import and export privileges by ensuring compliance with customs laws, commerce laws, and other governmental regulations can only occur if a system and process is in place to achieve these goals. Further, an efficient import process promotes and facilitates international business transactions overall with minimal exposure to customs duties and transportation costs. Therefore, an automated system and process for efficiently managing import/export activity and related data among various entities is quite desirable.

### SUMMARY OF THE INVENTION

In an aspect of the invention, a method of improving compliance with customs laws is provided. The method comprises the steps of receiving commercial invoice data electronically from a supplier, the commercial invoice data having one or more identifiers and validating the commercial invoice data for compliance with at least one requirement of customs including at least checking the one or more identifiers against a classification system associated with the at least one requirement.

The method further comprises the steps of transmitting the validated commercial invoice data electronically to an end user for making declarations to customs. The method may also comprise the steps of flagging invalid or missing classification of the one or more identifiers against the classification system prior to submission of the commercial invoice data to the customs and checking the commercial invoice data for completeness and correctness against predetermined required information. Further, the method may also comprise the steps of detecting prohibited identifiers and issuing an alert identifying the prohibited identifiers.

In another aspect of the invention, a method of managing importation of goods is provided. The method comprises the steps of comparing data of a shipment notification and a commercial invoice for a match of predefined criteria and if the match of predefined criteria is satisfied, checking the commercial invoice for compliance with at least one requirement of a governmental agency. The method further comprises forwarding an entry declaration to a customs broker electronically when the commercial invoice is deemed compliant with the at least one requirement of the governmental agency.

The method may also comprise the steps of receiving shipping notification data electronically that references at least the commercial invoice and matching required contents of the referenced commercial invoice to the shipping notification data and sending a notification when no match occurs to resolve the matching step. The method may also comprise comparing one or more parts listed in the referenced commercial invoice when a match occurs to a classification in a tariff schedule and creating an error report when the comparing step fails to match the one or more parts listed in the referenced commercial invoice to the tariff schedule.

In another aspect of the invention, a system for managing importing of goods is provided. The system comprises at least one component to receive commercial invoice data having one or more listed parts and an invoice number and to validate the commercial invoice data for compliance with at least one requirement of a governmental agency to at least check the one or more listed parts against a classification system. The system further comprises the at least one component to transmit an entry declaration which includes at least one of the one or more listed parts when the commercial invoice data has been successfully validated to make declarations to customs.

The system may also comprise the at least one component to flag invalid classification of the one or more listed parts against the classification system associated with at least one requirement of the customs prior to submission of the commercial invoice data to a customs broker. The system may also comprise the at least one component to check the commercial invoice data for completeness and correctness, to receive shipping notification from a freight forwarder and to verify the shipping notification against the commercial invoice data received and to flag any inconsistencies between the shipping notification and the commercial invoice data for remedial action prior to transmitting the commercial invoice data to the customs broker. The system may also comprise the at least one component to transmit the commercial invoice data to the customs broker for creating the entry declaration based on the commercial invoice data, to receive the entry declaration from the customs broker and to check the entry declaration for reverse compliance after submission to the customs.

In another aspect of the invention, a system for controlling goods for importation is provided. The system comprises means for receiving shipping notification having data from a freight forwarder, means for receiving a commercial invoice having one or more listed goods from a supplier, means for comparing data between the commercial invoice and data of the shipping notification and means for verifying that data listed on an entry declaration matches the data listed on at least any one of the commercial invoice and the shipping notification to ensure compliance with import regulations.

In another aspect of the invention, a system for controlling goods for importation is provided. The system comprises means for receiving shipping notification having data from a freight forwarder and means for receiving a commercial invoice having one or more listed goods from a supplier. The system further comprises means for comparing data between the commercial invoice and data of the shipping notification and means for verifying that data listed on an entry declaration matches the data listed on at least any one of the commercial invoice and the shipping notification to ensure compliance with import regulations.

### BRIEF DESCRIPTION OF THE DRAWINGS

FIG. 1 is an illustration of an exemplary environment of the invention;

FIG. 2 is a functional block diagram of an embodiment of the invention;

FIGS. 3A and 3B are functional block diagrams showing various modules and interfaces of a compliance system, according to the invention;

FIG. 4 is a functional block diagram of an embodiment of a system of the invention;

FIG. 5 is a functional block diagram showing creation of a “combo” file, in accordance with the invention; and

FIGS. 6A-6D are flow diagrams illustrating an embodiment showing steps of using the invention.

### DETAILED DESCRIPTION OF EMBODIMENTS OF THE INVENTION

This invention is generally directed to a system and method for managing exportation and importation and the data and interactions of entities involved. The invention provides timely importation of goods by coordinating a number of various activities and cross-checking for accuracy and compliance.

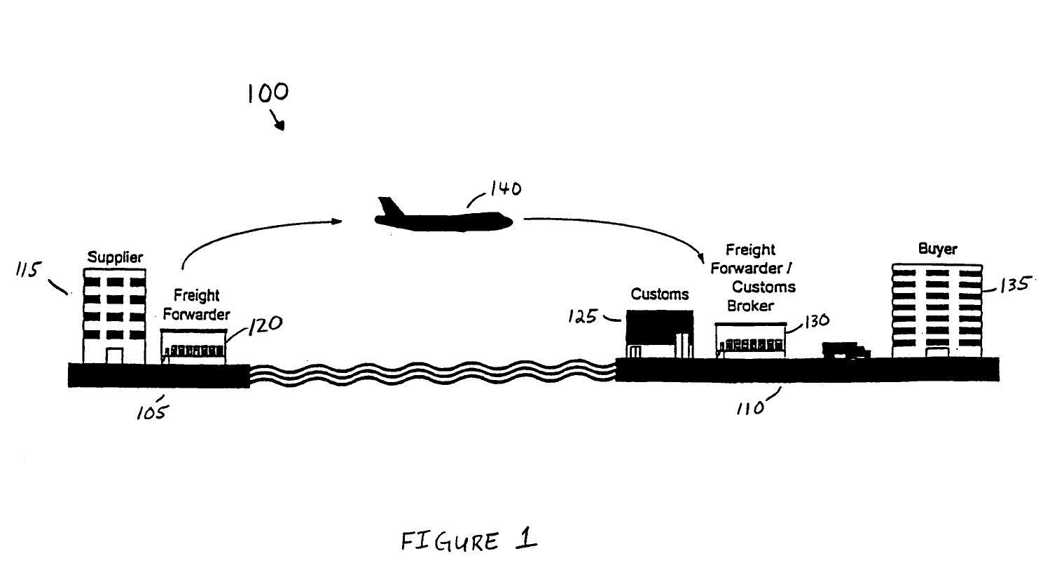

FIG. 1 is an illustration of an exemplary environment of the invention, generally denoted by reference numeral 100. The environment 100 may include an exporting country 105, generally a foreign country relative to an importing country, the importing country 110 which may be distant or near the exporting country 105, a supplier 115 of goods typically located in the exporting country 105 and a freight forwarder 120 typically, but not necessarily, located in the exporting country.

The environment 100 may also include customs 125, a customs broker 130 which, in embodiments, may also be the same entity as the freight forwarder in the importing country, a buyer 135 which may be corporation, organization, or other entity receiving imported goods. Also included may be a shipper 140 illustrated as an airline, but may be any type of transportation carrier, for transporting goods from an exporting country to an importing country.

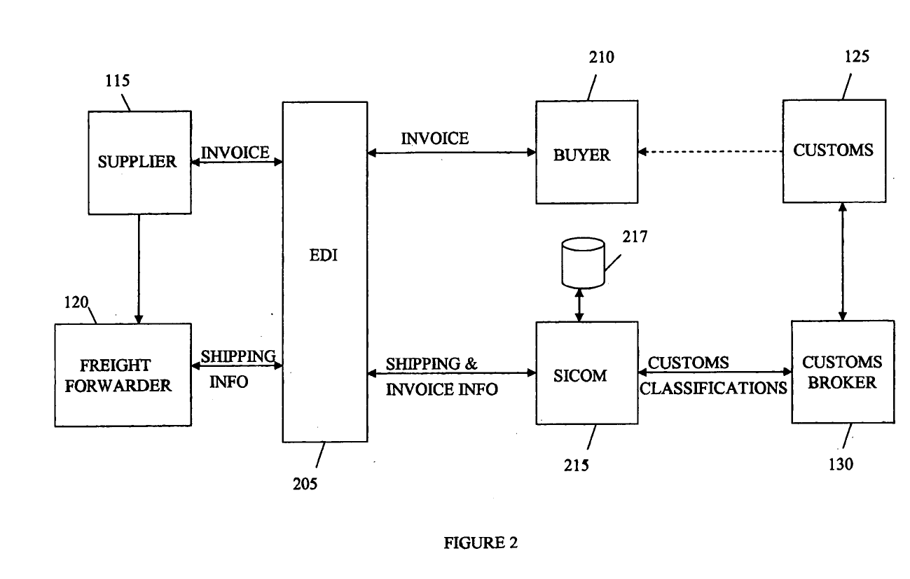

FIG. 2 is a functional block diagram of an embodiment of the invention, generally denoted by reference numeral 200. The embodiment 200 may comprise an electronic data interface (EDI) 205 typically having appropriate databases for interfacing various entities such as the supplier 115 and freight forwarder 120 to a compliance system 215, generally known as SICOM, and perhaps to a buyer 210 as necessary. In embodiments, the SICOM system and supporting components may be embodied as a corporate entity or part of a corporate entity, to coordinate import operations on behalf of corporate divisions, and/or corporate customers. In other embodiments, SICOM may be deployed as a service to manage and oversee importation operations on behalf of multiple corporate customers or other entities.

In embodiments the EDI 205 may be a part of the compliance system 215, perhaps distributed. As part of its function, the EDI 205 permits the supplier 115 to submit data such as an invoice for goods to be processed by the compliance system 215. The EDI 205 may be located in a foreign country or otherwise localized in a region, as necessary, for facilitating reception and input of data or export/import information. For example, a large corporation may have numerous suppliers in Europe, for example, so an instance of EDI 205 may be established somewhere in Europe for facilitating interfacing with those suppliers. In embodiments, the EDI 205 may also be considered a distributed component of the compliance system 215. A freight forwarder 120 may also submit shipping information, such as shipping notifications, via the EDI 205 to the compliance system 215.

The embodiment 200 may also include one or more databases 217 for maintaining various types of data such as, for example, ongoing records of shipments, compliance requirements, classification systems, accounting data, freight tables, shipping data and scheduling information, governmental requirements, customs requirements, supplier information, part numbers, and the like.

The compliance system 215 may also communicate with the customs broker 130 as necessary to provide validated invoice data and shipping information to the customs broker for generating an entry declaration to customs 125. The customs 125 may receive the entry declaration in anticipation of arrival of a shipment from the exporting entity for clearance purposes. The customs broker 130 may also return the submitted entry declaration to the compliance system 215 for reverse compliance, as discussed below.

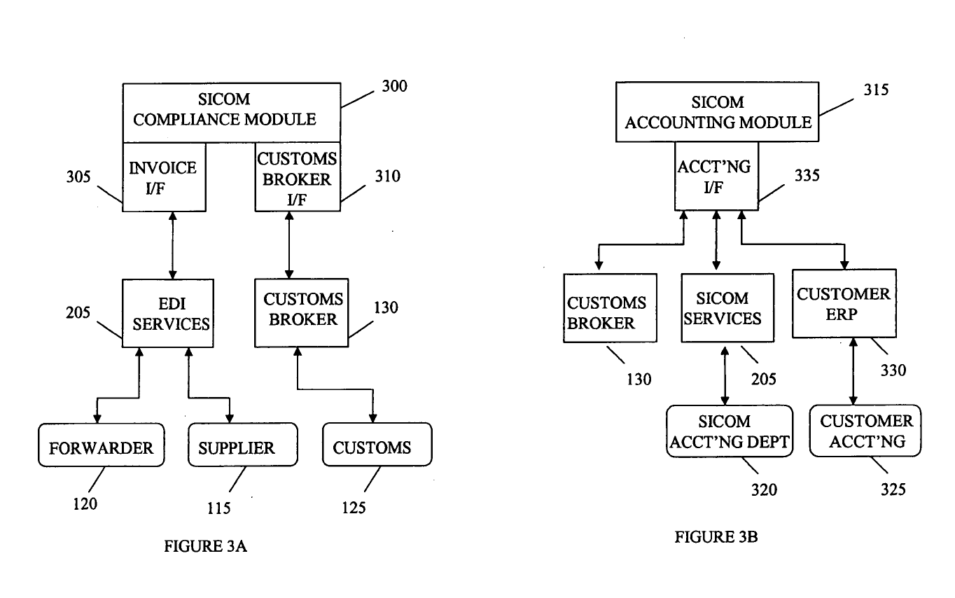

FIGS. 3A and 3B are functional block diagrams showing various modules and interfaces of the compliance system 215, according to the invention. Referring to FIG. 3A, a compliance module 300 provides extensive checking of data from the various entities (e.g., freight forwarders and suppliers) so that the export/import process may be accomplished efficiently and with minimal errors and may identify issues prior to submission of an entry declaration to customs or prior to actual shipment of goods from the exporting country. This early detection may thus minimize undesirable disruptions in the supply chain. Identifying errors or non-compliant documentation or goods early in the export/import process prevents unnecessary delays in the overall delivery process. Moreover, identifying restricted goods or parts prior to involving customs (e.g., submitting an entry declaration listing forbidden goods or parts) may avoid unnecessary financial, scheduling, supply, or legal entanglements and may maintain good business relationships among all the entities involved in the export/import cycle. The various data reviewed for compliance may have various types of identifiers associated with different listed items such as, for example, invoice numbers, delivery note numbers, part numbers, classification numbers, counts, supplier and vendor IDs, valuations, shipper IDs, and the like.

The compliance module 300 may provide various interfaces such as an invoice interface 305 for submission of invoices from or to freight forwarders 120 or suppliers 115. The EDI 205 may be made available to receive the invoices in various formats and/or via certain pre-agreed communication protocols, such as, for example, Electronic Data Interchange for Administration, Commerce, and Transport (EDIFACT). Further, the customs broker interface 310 permits reception of data from or to customs brokers. The data might include shipping information and invoice data, for example, which may be sent by the compliance system to the customs broker 130, who in turn may communicate information such as entry declarations to customs 125.

Referring to FIG. 3B, an accounting module 315 is provided by the compliance system 215 and may include an accounting interface 335 to receive billing invoices and to generate and send reports or payments to various entities, for example. The accounting interface 335 may also provide reports and data to personnel managing the SICOM system 215. The accounting interface 335 may also provide appropriate communication protocols to one or more customs broker 130 to facilitate reports, transactions and payments. The accounting interface may also provide an Enterprise Resource Planning (ERP) portal for various customers' access to transact commercial business interactions such as accounts payable and receivable, returns, or the like. The accounting interface may support common formats and protocols for systems such as from vendors SAP®, Oracle®, PeopleSoft®, and similar vendors.

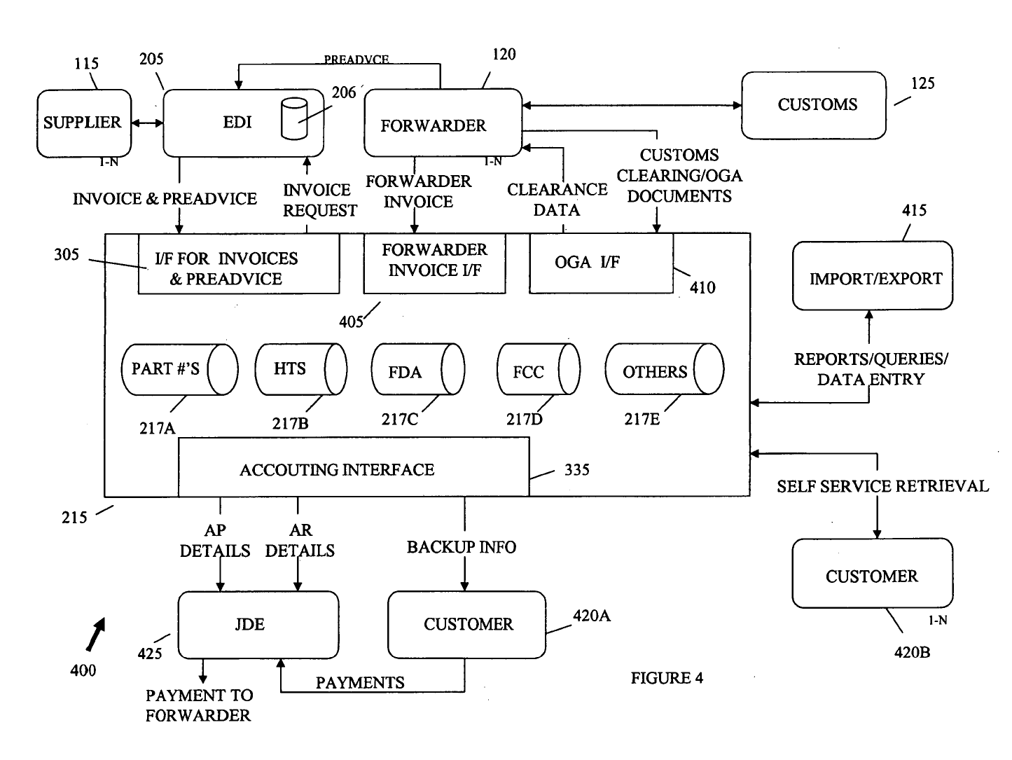

FIG. 4 is a functional block diagram of an embodiment of a system of the invention, generally denoted by reference numeral 400. The system 400 shows various components and interactions among various entities supported by the system. The system includes SICOM 215 comprising an interface for invoices and preadvice 305, accounting interface 335, freight forwarder interface 405 and other government agencies interface 410. The other government interface 410 may support interactions with such other government agencies as, for example, Federal Communications Agency (FCC), Federal Drug Agency (FDA), Energy Department, Defense Department, Commerce Department, Agriculture Department, and the like. These agencies may have other designations depending on circumstances or countries involved but are meant to represent examples of the types of other governmental agencies that may be involved in regulating importation or exportation of goods and may of course include other generally known agencies. Various databases 217A-217E may also be a part of SICOM. The databases 217A-217E may include a database for parts 217A, a database for tariff schedules 217B, databases for pricing and shipping rates (e.g., 217E), and databases to support compliance with the various other governmental agencies, e.g., 217C-217D. The integrity of the various databases including compliance information is typically maintained and/or updated by personnel assigned to managing the SICOM system.

The SICOM system may employ various technologies such as Java Development Environment for Emacs (JDEE) based web interfaces, Websphere® application servers, SQL servers, Crystal Reports® for customer forms and reports, and PGP® encryption for secure EDI with external entities, to name just a few, as one of ordinary skill in the art should recognize. Other technologies may be employed as appropriate.

The freight forwarder 120 may notify SICOM of a shipment of goods via the EDI 205 by supplying a shipment notification, also known as a preadvice. The shipping notification may include a delivery note number, also known as a dispatch number, for identifying the shipment so that commercial invoices may be associated with the shipment. The shipping notification may be stored in database 206. One or more suppliers 115 may submit commercial invoices each having an invoice number via the EDI 205 which may be stored in database 206. The EDI 205 processes the shipping notification using the delivery note number, for example, to index the database to locate any commercial invoices submitted by suppliers and associated with the shipping notice. Invoice numbers may also be used to locate the invoices associated with the shipping notification. The EDI 205 combines the shipping notification and any associated invoices into a “combo” file and forwards the “combo” file to SICOM 215 for further processing. On occasion, SICOM 215 may request commercial invoices from suppliers 115 when an invoice has been determined to be missing via EDI 205.

As discussed more below in reference to the flow diagrams, SICOM 215 processes the “combo” file and performs various compliance checks to insure that the commercial invoice data and shipping notification data is consistent, complete, accurate and conforms to various requirements and regulations prior to submission to the freight forwarder 120 for performing customs broker functions (in embodiments, a separate customs broker may be used in lieu of a freight forwarder to accomplish customs broker functions), and prior to submission of an entry declaration to customs.

Forwarder 120 may also submit invoices for services rendered to SICOM via forwarder invoice interface 405. In the embodiment of FIG. 4, the freight forwarder 120 is also shown as also being a customs broker (or otherwise performing custom broker functions). The freight forwarder 120 may also request clearance data requirements or information from SICOM databases 217B-217E as necessary in order to create an entry declaration based on the provided commercial invoice data and shipping notification data for timely submission to customs 125.

The timing of the submission of the entry declaration by the freight forwarder may also be contingent upon receiving a substantially real time notification of the actual departure of a shipment from the exporting country. This coordinated submission of the entry declaration with the shipment may be most appropriate for shipment by air. In this case, a “wheels-up” notification by the air freight carrier (or, perhaps the freight forwarder) denotes that the aircraft bearing the shipment has actually taken-off and is en route to the port of entry. In embodiments, this “wheels-up” notification may trigger submission of the entry declaration, typically electronically, to customs in anticipation of eminent arrival of the shipment. The “wheels-up” notification may obtain earlier entry into the customs clearance queue for expediting processing by customs overall and, hence, more efficient overall supply line operations.

The system 400 may accept commercial invoice data and shipping electronically and provides this data to freight forwarders (or customs brokers) electronically; thereby manual entry of data may be avoided at each of these stages resulting in minimal errors. In addition, the integrity of the data on the electronic invoice is maintained so that the data is in-sync with the data of the physical invoice accompanying the merchandise or goods in the shipment.

Continuing with FIG. 4, the system 400 may include an interface 415 for importing/exporting information such as reports, queries, data entry or the like by system personnel. Moreover, the system 400 may include an interface for a customer 420 to acquire information to support business operations on a self-service basis. In addition, a JD Edwards accounting system (JDE) 425 (or similar accounting system) for facilitating payments or interchange of accounting information such as accounts payable or accounts receivable may be provided.

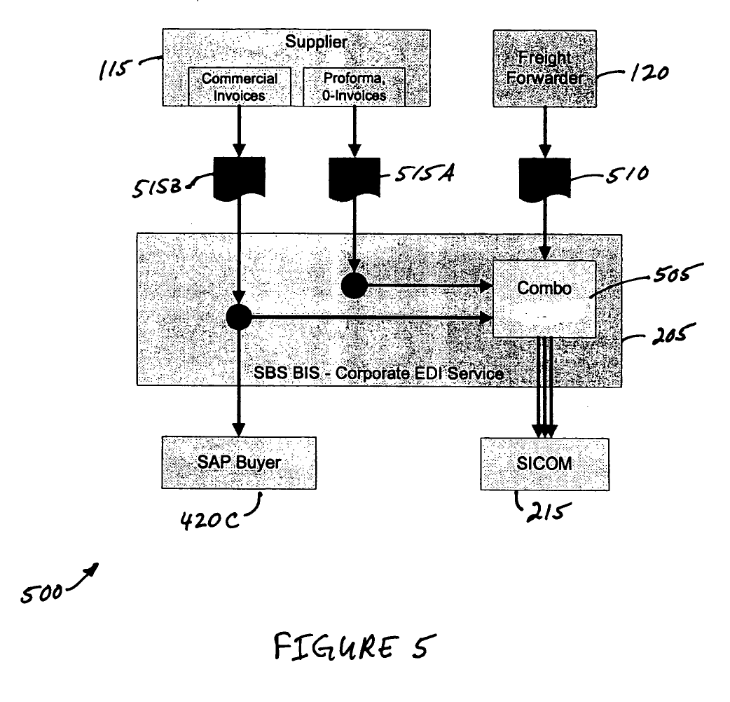

FIG. 5 is a functional block diagram showing creation of a “combo” file, generally denoted by reference numeral 500. EDI 205 may receive one or more invoices 515A (a commercial invoice) and 515B (a proforma invoice) from a supplier 115 and may also receive a shipping notification 510 (typically at a later date) with data from a freight forwarder 120. The shipping data may include various types of information such as a bill number, expected shipment date, port of lading, port of entry and delivery number, to name a few.

The supplier 115 submits the one or more invoices 515A (commercial invoice), 515B (proforma invoice) via EDI 205, perhaps many instances of each at various times. On occasion, several different suppliers may be involved, each submitting one or more invoices or proforma invoices. The commercial invoices 515 may include various types of information such as, for example, invoice number, supplier ID and contact information, part numbers, part description, harmonized tariff schedule (HTS) number of exporting country, country of origin (C/O) on the commercial invoice, unit price, net amount, counts of items, shipper ID, and the like. The proforma invoice 515B may be stored in the EDI database 206 (FIG. 4). The commercial invoice 515A may be forwarded along to a buyer 420C (or customer), as appropriate. The EDI 205 creates a “combo” file 505 by searching for all proforma invoices having invoice numbers that match the one or more invoice numbers on the shipping notification, perhaps also using a delivery number on the shipping notification, as necessary, by searching the EDI database 206 (FIG. 4). The “combo” file 505 comprises the matching invoices with their data and the shipping notification with its data. This “combo” file 505 is then forwarded on to SICOM for further processing.

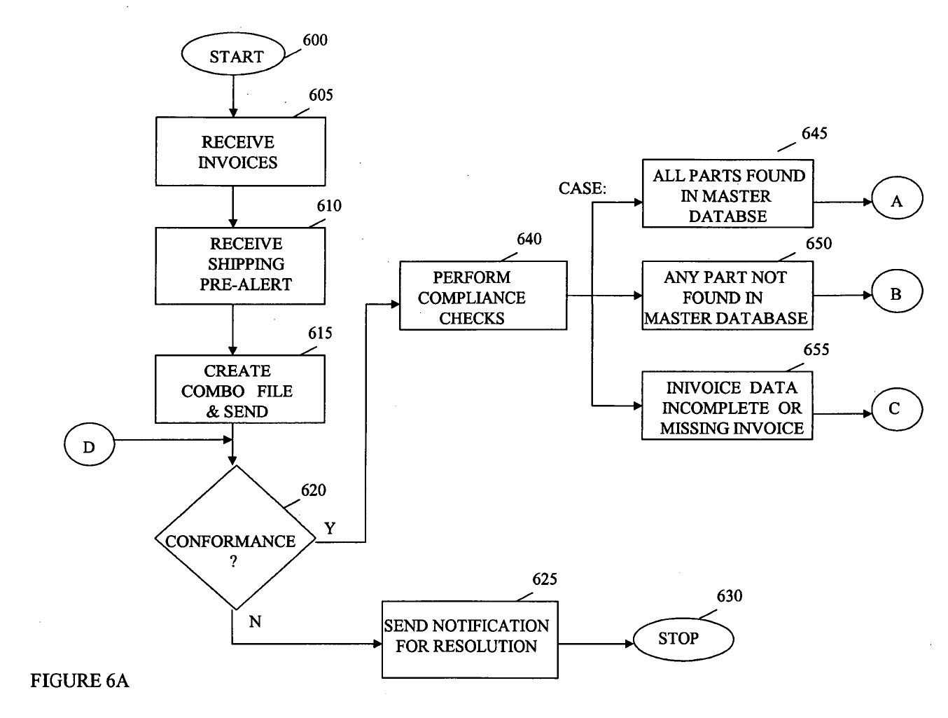

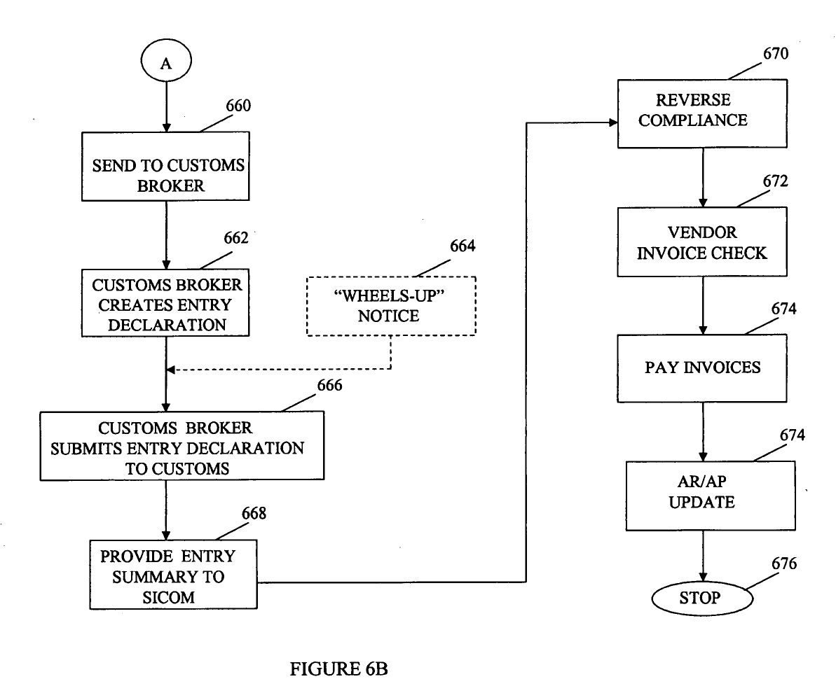

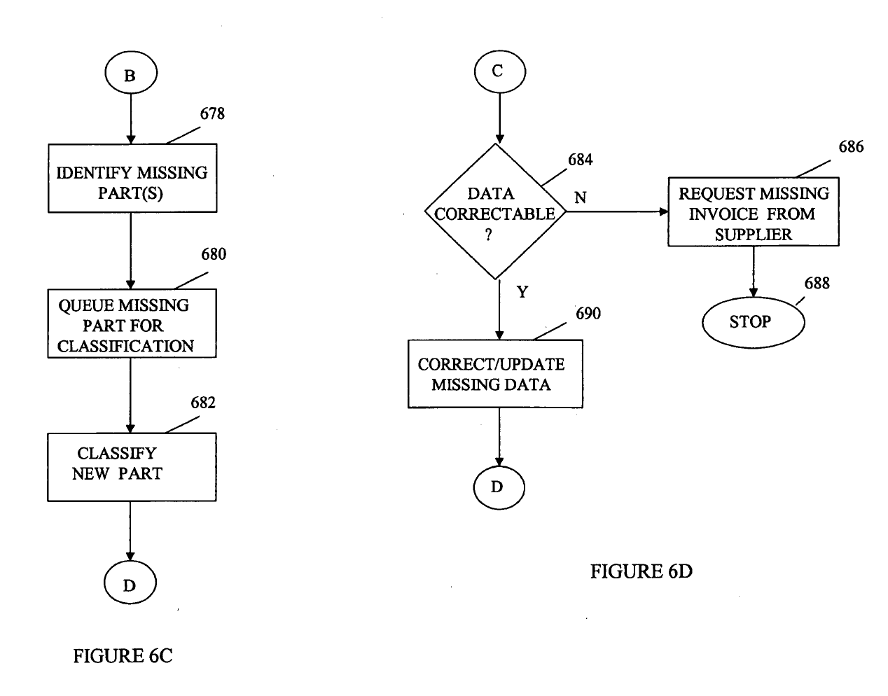

FIGS. 6A-6D are flow diagrams of an embodiment showing steps of using the invention, starting at step 600. FIGS. 6A-6D (and all the other flow and functional diagrams) may equally represent a high-level block diagram of components of the invention implementing the steps thereof. The steps of FIG. 6A-6D (and all the other flow and functional diagrams) may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

Continuing with FIG. 6A, at step 605, one or more invoices may be received from one or more suppliers and stored until a shipping notification or pre-alert is received. At step 610, the shipping notification may be received from a freight forwarder, typically when the shipment is ready to ship. The shipping notification may include a bill of lading possibly listing such items as a delivery number, airway bill, expected ship date, expected arrival date, shipper ID, and the like. This real-time shipping notification typically triggers a chain of events. At step 615, a “combo” file may be created triggered by the shipping notification data by acquiring invoices associated with the delivery number or dispatch number of the shipping notification. The “combo” file may then be passed or forwarded to a compliance system.

At step 620, the “combo” file is checked for formal conformance with expected formats and completeness, e.g., all required fields are present, or against pre-defined criteria. An incorrect delivery note may cause a error report to be issued, for example. Any inconsistencies of data between the invoices and shipping notification may be flagged for remedial action, as necessary. If the conformance step fails, then at step 625, a notification is sent to appropriate personnel based on the nature of the non-conformance and the process ends at step 630.

If, however, the conformance checks are successful, then at step 640, one or more compliance checks are made to determine whether the data listed in the invoices are in compliance with regulations and at least one requirement of customs, often many requirements. Further, a check (represented at step 640) may be made for conformance with regulations of other governmental agencies such as, for example, agriculture, food and drug (FDA), FCC, commerce, homeland security, or similar agencies of the government.

Moreover, another compliance cross-check (represented at step 640) may also be made to check any listed part numbers against a master part number database to insure accuracy. Any parts not in the database may result in a missing part notification message being generated, which may delay the overall importation processing. Further, another compliance check (represented at step 640) may also be made of one or more listed part numbers or goods against a classification system (e.g., HTS) to assure proper classification. Improper classification also generates notices for resolution of the problem. Adjustments to data in the “combo” file may also be made as necessary to update inaccurate or incomplete information for expediting the process.

These one or more compliances checks insure that the shipment and invoice data are in order prior to submission of entry documents to customs based on the shipment and invoice data including a check for accurate parts counts and valuation. These compliance checks are typically completed prior to sending invoice and shipping data to a customs broker and before creating an entry declaration, thus, avoiding delays and avoiding misrepresentations to customs and any possible penalties due to misrepresentations. By identifying non-conformance or non-compliance issues earlier in the importation cycle, resolution of issues might occur without jeopardizing schedules or available supplies of goods to the importer.

Continuing now with FIG. 6A, depending on the results of the compliance checks, several actions may occur which are represented by the CASE switch function. The processes associated with the CASE continue with FIGS. 6B and 6C, as appropriate. The results of the CASE continue at steps 645, 650, or 655, as appropriate.

Continuing now with the first case, at step 645, if all parts are found in the master database and no other non-compliance is determined, then at step 660, the invoice data and shipping notification data (e.g., as associated with the “combo” file) may be sent electronically to a customs broker (alternatively, to a freight forwarder performing customs broker functions). At step 662, the customs broker may create an entry declaration in compliance with customs formats and regulations based on the invoice data and shipping notification data (e.g., “combo” file).

At optional step 664, a “wheels-up” notification may be received by the customs broker (perhaps through SICOM) indicating that a shipment is en route and submission of the entry declaration may commence. At step 666, the customs broker submits the entry declaration electronically to customs in a required format. At step 668, an entry summary (e.g. a customs form number 7501 information, or similar form) may be returned to the SICOM system electronically by the customs broker after submission of the entry declaration. If electronic communication is not available, then physical communication of submissions and summaries may occur. Customs may provide status messages back to SICOM such as, for example, “customs release” of shipment, a “hold” holding a shipment in customs, or an “examination required.” These messages may be relayed via the customs broker, and these messages may be tracked by SICOM for monitoring and follow-up as necessary.

At step 670, a reverse compliance check may be performed by SICOM to assure that the entry declaration, as submitted, accurately lists all data that was initially provided to the customs broker. This may be accomplished by checking the entry summary against the commercial invoice data and shipping notification data previously submitted to the customs broker. This may involve checking the entry summary with the submitted data to the customs broker along with re-confirming the listed entry summary information in master SICOM databases.

For example, a reverse compliance check may include checking the airway bill number and associated data received in the entry summary with airway data on file for that airway bill (typically a part of a shipping notification). If any discrepancies are found, an error report may be generated. Further, HTS and invoice numbers may be reconfirmed by comparing with stored information in the SICOM databases. Any listed invoices may also have data reconfirmed, including any counts and valuations. Any classification made on the entry summary may also be re-confirmed. Any discrepancies in any reverse compliance check may produce an error report.

On occasion, a customs broker may resend an entry summary, with a same entry number, perhaps due to a correction made by the customs broker. In this case, versions of entry summaries may be maintained and logged by SICOM to incrementally achieve a satisfactory reverse compliance check.

At step 672, one or more vendor invoices may be received for services rendered from one or more vendors (e.g., freight forwarders, customs brokers, suppliers, or other similar vendors). These vendor invoices may be checked for accuracy such as, for example, data for freight charges, duties, surcharges, or the like. At step 674, when the vendor invoices are deemed accurate, the vendor invoices may be paid. This may include paying a vendor in bulk for more than one invoice, if appropriate, or, if a discrepancy is found in one or more vendor invoices for a particular vendor, withholding payment of the invoice with the discrepancy from bulk payment and paying the withheld invoice separately when manually resolved or otherwise authorized. The bulk payment process may occur automatically without manual intervention to expedite the overall business relationships.

At step 674, the accounts payable and accounts receivable details, i.e., databases, may be automatically updated with new or amended records reflecting payment transactions. A backup of this information may also be created. At step 676, the process ends.

Continuing now with the second case at step 650, if any part is not found in the master database, then at step 678, the missing part(s) may be identified and, at step 680, queued in a missing parts queue (or otherwise notification sent) for remedial action. The missing part queue provides a controlled presentation to personnel for manually supplying a part number, supplier ID, classification and/or description, for example, to reconcile the missing part (which may be a new part to the system). At step 682, the new part or missing part may be classified or otherwise entered in to the master database. Processing continues at step 620 with the new part information now available.

Continuing now with the third case condition, at step 655, if any invoice data is incomplete or an invoice is missing, then at step 684, a check is made to see if the missing data may be corrected by other information on-hand or manually by personnel. For example, a blocked invoice may require special attention, perhaps interaction with a supplier or other entity in the submission path, or, if valuations are improper such as a zero amount, then the valuations may require manual resolution. If the missing data is correctable, then at step 690, the missing data is corrected and updated in the associated files. The process then continues at step 620.

If however, the data is not correctable or an invoice is missing, then at step 686, a request may be sent to an appropriate submitting entity requesting that the missing or non-correctable invoice be resubmitted. At step 688, the process then stops or suspends until a new or replacement invoice is provided. A notification may also be produced for reporting the request to management personal and to monitor the progress of the new invoice request. Once the new or replacement invoice is received, an appropriate update to a SICOM database occurs and the conformance and compliance checks resumed.

The system and method also provides logging and tracking of progress of all notifications and submissions from and to all entities. Tracking of customs status messages may also be provided to responsible parties overseeing a particular import operation. Emails may also be generated relaying customs status messages to specific responsible parties. A search and retrieval of any status may also be accomplished when needed, by submission or message.

The system and method of the invention provides efficient coordination among various entities involved with exportation/importation processes. Various improvements may be achieved by the system and method including for example:
Improved verification of shipping notifications with invoices and checking of required information between them.
Improved provisions for checking compliance with other governmental agency's' regulations other than customs, e.g., agriculture agencies, defense agencies, food and drug agencies, security agencies, and the like.
Better detection and more effective checking of illegal or controlled goods on invoices and shipping bills in a timely manner to avoid inadvertent shipment of these illegal or controlled goods to an importing country while they are still in the exporting country and/or prior to submission of the entry declaration to customs.
Improved and more effective verification of goods/parts classification listed on invoices and entry declarations that are consistent with known classification systems.
Significant checking of customs brokers submissions for accuracy against invoices or shipping notices.
Tracking delivery status messages.
Cross-checking of air freight and surcharges against pre-determined schedules.
Ability to automatically notify process “owners” when a compliance issue arises to resolve a non-compliance or error expeditiously.
Automatic payment of invoices in bulk when the invoices match expected charges and no automatic method to pay a single invoice independently when an exception or error arises on a particular invoice.

While the invention has been described in terms of embodiments, those skilled in the art will recognize that the invention can be practiced with modifications and in the spirit and scope of the appended claims.

1. A method of improving compliance with customs laws, comprising the steps of:
receiving commercial invoice data electronically from a supplier, the commercial invoice data having one or more identifiers;
validating the commercial invoice data for compliance with at least one requirement of customs including at least checking the one or more identifiers against a classification system associated with the at least one requirement; and
transmitting the validated commercial invoice data electronically to an end user for making declarations to customs.

2. The method of claim 1, further comprising the steps of:
flagging invalid or missing classification of the one or more identifiers against the classification system prior to submission of the commercial invoice data to the customs; and
checking the commercial invoice data for completeness and correctness against predetermined required information.

3. The method of claim 2, wherein the checking step comprises:
detecting prohibited identifiers; and
issuing an alert identifying the prohibited identifiers.

4. The method of claim 1, further comprising the steps of:
receiving shipping notification electronically from a third party;
comparing the shipping notification against the commercial invoice data received from the supplier; and
flagging any inconsistencies between the shipping notification and the commercial invoice data for remedial action prior to the transmitting step.

5. The method of claim 1, further comprising the steps of:
sending the commercial invoice data electronically to a third party;
receiving an entry declaration electronically from the third party, which includes the commercial invoice data; and
checking the electronic entry declaration after submission to customs for reverse compliance against the commercial invoice data.

6. The method of claim 5, wherein the checking step comprises checking accuracy of at least any one of:
i) a classification of the one or more identifiers listed in the entry declaration,
ii) a valuation of the one or more identifiers listed in the entry declaration, and
iii) counts of each of the one or more identifiers listed in the entry declaration.

7. The method of claim 1, wherein the validating step includes checking the commercial invoice data for conformance with requirements of at least one government agency other than customs.

8. The method of claim 1, further comprising the steps of:
receiving shipping notification electronically from a third party that includes a bill of lading specifying at least any one of a delivery number, airway bill, expected ship date, expected arrival date, shipper identification, port of lading and port of unlading;
creating a combo-file that incorporates the commercial invoice data and at least portions of the bill of lading; and
transmitting the at least any one of the commercial invoice data and at least a portion of the combo-file to the end user for making the declarations to customs.

9. The method of claim 1, wherein the end user is a customs broker and the one or more identifiers is at least any one of a name, a part number, a goods identifier and a classification.

10. A method of managing importation of goods, comprising the steps of:
comparing data of a shipment notification and a commercial invoice for a match of predefined criteria;
if the match of predefined criteria is satisfied, checking data of the commercial invoice for compliance with at least one requirement of a governmental agency; and
forwarding the checked data of the commercial invoice to a customs electronically to make an entry declaration to the customs when the commercial invoice is deemed compliant with the at least one requirement of the governmental agency.

11. The method of claim 10, further comprising the steps of:
receiving shipping notification data electronically that references at least the commercial invoice;
matching required contents of the referenced commercial invoice to the shipping notification data and sending a notification when no match occurs to resolve the matching step;
comparing one or more parts listed in the referenced commercial invoice when a match occurs to a classification in a tariff schedule; and
creating an error report when the comparing step fails to match the one or more parts listed in the referenced commercial invoice to the tariff schedule.

12. The method of claim 10, wherein the forwarding step includes forwarding electronically the commercial invoice to a customs broker prior to forwarding the entry declaration to the governmental agency.

13. The method of claim 10, further comprising the steps of:
validating the commercial invoice for completeness and correctness; and
creating an error notice when the commercial invoice is at least any one of incomplete, incorrect and missing required information.

14. The method of claim 10, further comprising the steps of:
receiving the entry declaration electronically from the customs broker, which includes data from the commercial invoice; and
checking the entry declaration after submission to the customs for reverse compliance.

15. The method of claim 14, wherein the checking the entry declaration step comprises checking the accuracy of at least any one of:
i) a classification of one or more listed parts listed in the entry declaration,
ii) a valuation of the one or more listed parts listed in the entry declaration, and
iii) at least one count of each of the one or more listed parts listed in the entry declaration.

16. The method of claim 10, further comprising checking the commercial invoice for conformance with requirements of the governmental agency.

17. The method of claim 10, further comprising the steps of:
checking the commercial invoice to detect prohibited goods; and
issuing an alert identifying the detected prohibited goods to prevent entry of the detected prohibited goods into an importing entity.

18. The method of claim 17, wherein the issuing an alert step comprises sending an email notification to a predetermined addressee based on a type of compliance fault.

19. The method of claim 10, further comprising the steps of:
receiving at least one vendor invoice electronically from a customs broker;
verifying data of the at least one vendor invoice for air freight charges, duties and surcharges; and
paying one of:
a plurality of vendor invoices when the plurality of vendor invoices are deemed accurate, and
at least one invoice of the plurality of vendor invoices individually when the at least one invoice is deemed at least in part inaccurate.

20. A system for managing importing of goods, comprising at least one component to:
receive commercial invoice data having one or more listed parts and an invoice number;
validate the commercial invoice data for compliance with at least one requirement of a governmental agency to at least check the one or more listed parts against a classification system; and
transmit an entry declaration which includes at least one of the one or more listed parts when the commercial invoice data has been successfully validated to make declarations to customs.

21. The system of claim 20, wherein the at least one component flags invalid classification of the one or more listed parts against the classification system associated with at least one requirement of the customs prior to submission of the commercial invoice data to a customs broker.

22. The system of claim 20, wherein the at least one component:
(i) checks the commercial invoice data for completeness and correctness;
(ii) receives shipping notification from a freight forwarder;
(iii) verifies the shipping notification against the commercial invoice data received and flags any inconsistencies between the shipping notification and the commercial invoice data for remedial action prior to transmitting the commercial invoice data to the customs broker; and
(iv) transmitting the commercial invoice data to a customs broker for creating the entry declaration based on the commercial invoice data, receiving the entry declaration from the customs broker; and checking the entry declaration for reverse compliance after submission to the customs.

23. The system of claim 20, wherein the at least one component detects prohibited goods and issues an alert identifying the prohibited goods to prevent entry into an importing entity.

24. The system of claim 20, wherein the at least one component checks the accuracy of at least any one of:
i) a classification of the at least one of the one or more listed parts listed in the entry declaration,
ii) a valuation of the at least one of the one or more listed parts listed in the entry declaration, and
iii) a count of each of the one or more listed parts listed in the entry declaration.

25. The system of claim 20, further comprising the at least one component to receive a vendor invoice electronically and to verify the vendor invoice data for at least any one of air freight charges, duty, brokerage charges and surcharges.

26. The system of claim 25, wherein the at least one component provides instructions to accounts payable for paying the vendor invoice.

27. The system of claim 20, wherein the at least one component:
receives a shipping notification from a freight forwarder that includes a bill of lading having importing information; and
verifies a pre-advice at least in part against the commercial invoice data.

28. A system for controlling goods for importation, comprising:
means for receiving shipping notification having data from a freight forwarder;
means for receiving a commercial invoice having one or more listed goods from a supplier;
means for comparing data between the commercial invoice and data of the shipping notification; and
means for verifying that data listed on an entry declaration matches the data listed on at least any one of the commercial invoice and the shipping notification to ensure compliance with import regulations.

29. The system of claim 28, further comprising:
means for checking accuracy of the commercial invoice;
means for checking accuracy of the shipping notification; and
means for creating an error notification when an inaccuracy is detected on the shipping notification or commercial invoice.

30. The system of claim 29, wherein the means for checking accuracy of the shipping notification includes checking at least any one of a bill of lading, delivery note number and dates of delivery and shipping.

31. The system of claim 28, further comprising means for checking the accuracy of at least any one of:
i) a classification of one or more listed items in the entry declaration,
ii) a valuation of the one or more listed items listed in the entry declaration, and
iii) a count of each of the one or more listed items in the entry declaration.

32. The system of claim 28, further comprising:
means for receiving one or more invoices electronically from a vendor;
means for checking one or more charges billed by the vendor in the one or more invoices for accuracy; and
means for paying the vendor for the billed charges when deemed accurate.

33. The system of claim 28, further comprising means for checking the commercial invoice for conformance with requirements of a governmental agency other than customs.

34. The system of claim 28, further comprising:
means for correlating the shipping notification with the commercial invoice; and
means for validating data of the shipping notification with at least a portion of the commercial invoice.

35. The system of claim 28, further comprising means for flagging an invalid or missing classification of the one or more listed goods against a classification system associated with a requirement of customs prior to submission of the entry declaration to a customs broker.

36. The system of claim 35, wherein the requirement is associated with an importing entity.

37. The system of claim 36, wherein the importing entity is a country which is a port of entry for the one or more listed goods.

38. The system of claim 35, wherein the requirement is a harmonized tariff schedule (HTS).

39. The system of claim 35, further comprising means for receiving a wheels-up notification for triggering submission of the entry declaration to customs.
